(19) United States
(12) Patent Application Publication
(10) Pub. No.: US 2012/0044259 A1
(43) Pub. Date: Feb. 23, 2012

(54) DEPTH MANAGEMENT FOR DISPLAYED GRAPHICAL ELEMENTS

(75) Inventors: Alexandre Carlhian, Puteaux (FR); Guillaume Borios, Paris (FR)

(73) Assignee: Apple Inc., Cupertino, CA (US)

(21) Appl. No.: 12/857,912

(22) Filed: Aug. 17, 2010

(51) Int. Cl. G09G 5/00

(52) U.S. Cl. 345/629

(57) ABSTRACT

This is directed to re-defining the manner in which several graphical elements are overlaid on a display. A user can direct an electronic device display to provide several graphical elements, where the graphical elements can be associated with different depth orders. In some cases, several graphical elements can overlap, but may not have adjacent depth orders. To allow a user to quickly and easily bring a particular graphical element above or below an overlapping graphical element, the electronic device can identify the closest overlapping graphical element in depth order, and change the depth order of the overlapping graphical elements in response to a single instruction, independent of the number of intervening, non-overlapping graphical elements in the depth order.

### BACKGROUND

Using an electronic device, a user can direct the device to display different types of content. For example, a user can direct the device to operate an application by which a user can provide a text input for display by the application (e.g., a word processing application). As another example, a user can direct the device to operate an application by which a user can define graphical elements for display. The graphical elements can include one or more shapes (e.g., predefined shape templates such as, for example, circles, squares, rectangles, polygons, or shapes having curved surfaces). Several graphical elements can be overlaid or combined to form complex graphical shapes and entities displayed by the device. For example, graphical elements of different shapes and colors can be overlaid to form one or more complex images or information displays.

In some embodiments, a user can direct an electronic device to display several overlapping graphical elements. For example, a user can define a complex shape that includes several layers of graphical elements overlapping in different manners. In one implementation, each additional graphical element that a user selects to display can be incorporated in a new layer placed over all of the preceding layers. The new graphical element can then cover some or all of a graphical element of a preceding layer.

To create complex displays, it may be desirable for a user to move individual graphical elements above or below other displayed graphical elements. This can ensure that particular portions of a graphical element remain visible and displayed despite other graphical elements being provided on the display. The electronic device can provide several mechanisms for changing the order of graphical elements so that a particular graphical element moves towards the front or towards the back or rear of a display order stack. In one implementation, the electronic device can provide a mechanism by which a particular graphical element can become the rear-most graphical element (e.g., “send to back”) or the front-most graphical element (e.g., “send to front”). Using this mechanism, a particular graphical element can jump across several graphical elements within the display order stack.

In some embodiments, the electronic device can provide a mechanism by which an individual graphical element can move forward or backward relative to a single graphical element (e.g., change a depth order by one level). For example, a user can provide a “move forward” or a “move backward” instruction by which a selected graphical element moves forward or backward by one graphical element in a depth order. When a display includes a large number of graphical elements, and when not all of the graphical elements overlap, a user's instruction to move a particular graphical element forward or backward relative to a single graphical element may not cause a graphical element to move ahead or behind another graphical element. Instead, the display of a graphical element will change only when the user moves the graphical element forward or backward relative to enough graphical elements to change the order of the overlapping graphical elements. This approach can be time consuming and confusing for a user, as the user may not know the exact depth order of the graphical elements.

### SUMMARY

This is directed to systems, methods and computer-readable media for adjusting a depth order of a displayed graphical element such that an instruction to move a graphical element forward or backward will move the graphical element above or below an overlapping graphical element.

Using an electronic device, a user can select or define several graphical elements to provide on a display. The graphical elements can be associated with different depth orders or heights, such that the graphical elements can overlap and hide portions of one another in response to the user moving or placing the graphical elements on the display. The graphical elements can be defined with a depth order that a user can change by providing an appropriate instruction.

To improve a user's ease of interaction with the displayed graphical elements, the electronic device can enable the electronic device to dynamically adjust how much depth order varies in response to an instruction to change a depth order of a graphical element. In particular, an instruction to move a graphical element forward or backward can correspond to an instruction to move the layer forward or backward by a varying number of levels in the depth order.

The electronic device can use any suitable approach to determine how to revise the depth order of several graphical elements in response to receiving an instruction to move a particular graphical element forward or backward. In one implementation, the electronic device can identify other displayed graphical elements that overlap with the particular graphical element (e.g., other graphical elements for which a corresponding drawing box intersects with a drawing box of the particular graphical element). The electronic device can then identify the overlapping other graphical elements that are immediately below or above the graphical element (e.g., from a depth order), and move the particular graphical element above or below the identified overlapping other graphical elements in response to receiving an instruction. For example, the electronic device can identify the first other graphical element positioned above the particular graphical element, and move the graphical element on top of the first other graphical element in response to receiving an instruction to move the particular graphical element forward.

The electronic device can use any suitable data structure to represent the depth order of displayed graphical elements. In some embodiments, the electronic device can define an ordered array, stack, or linked list in which each entire is associated with a defined depth order of displayed graphical elements. In response to receiving an instruction to move a particular graphical element forward or backward, the electronic device can identify another graphical element for which the depth order is to change relative to the depth order of the particular graphical element. The electronic device can identify the entry associated with the other graphical element in the ordered array (or other data structure), and move the entry in the ordered array associated with the particular graphical element to a new position relative to the position of the entry associated with the other graphical element. In some embodiments, metadata values corresponding to depth order can be associated with each graphical element, and can change in response to receiving an instruction to move a particular graphical element forward or backward.

In some embodiments, the electronic device can determine that a particular graphical element does not overlap with any other graphical elements. Alternatively, the electronic device can determine that the particular graphical element does not overlap with any other graphical elements in a direction of change in depth order (e.g., forward or backward) corresponding to a received user instruction. In such cases, the electronic device can revert to a more traditional behavior of the instruction, where the depth order of the graphical element changes by only a single level.

### BRIEF DESCRIPTION OF THE DRAWINGS

The above and other features of the present invention, its nature and various advantages will be more apparent upon consideration of the following detailed description, taken in conjunction with the accompanying drawings in which:

FIGS. 1A and 1B are schematic views of illustrative displays of graphical elements in accordance with some embodiments of the invention;

FIGS. 2A-2C are schematic views of illustrative displays of several graphical elements in which the depth value of an element changes by more than one in accordance with some embodiments of the invention;

FIG. 3 is a schematic view of an illustrative display having several displayed graphical elements in accordance with one embodiment of the invention;

FIG. 4 is a flowchart of an illustrative process for changing a depth order of a graphical element in accordance with one embodiment of the invention;

FIGS. 5A-5C are schematic views of an illustrative data structure for storing depth order information in accordance with some embodiments of the invention;

FIG. 6 is a flowchart of an illustrative process for changing the depth order of displayed graphical elements in accordance with one embodiment of the invention;

FIG. 7 is a flowchart of an illustrative process for changing the manner in which graphical elements overlap on a display in accordance with one embodiment of the invention;

FIG. 8 is a flowchart of an illustrative process for changing a depth order associated with several displayed layers of content in accordance with one embodiment of the invention; and

FIG. 9 is a schematic view of an illustrative electronic device in accordance with one embodiment of the invention.

### DETAILED DESCRIPTION

This is directed to adjusting a depth order of particular displayed graphical elements in response to receiving a corresponding instruction, where the amount by which a depth order changes can vary based on the disposition of graphical elements on a display. In particular, this is directed to adjusting the depth order of graphical elements based on detected overlapping elements.

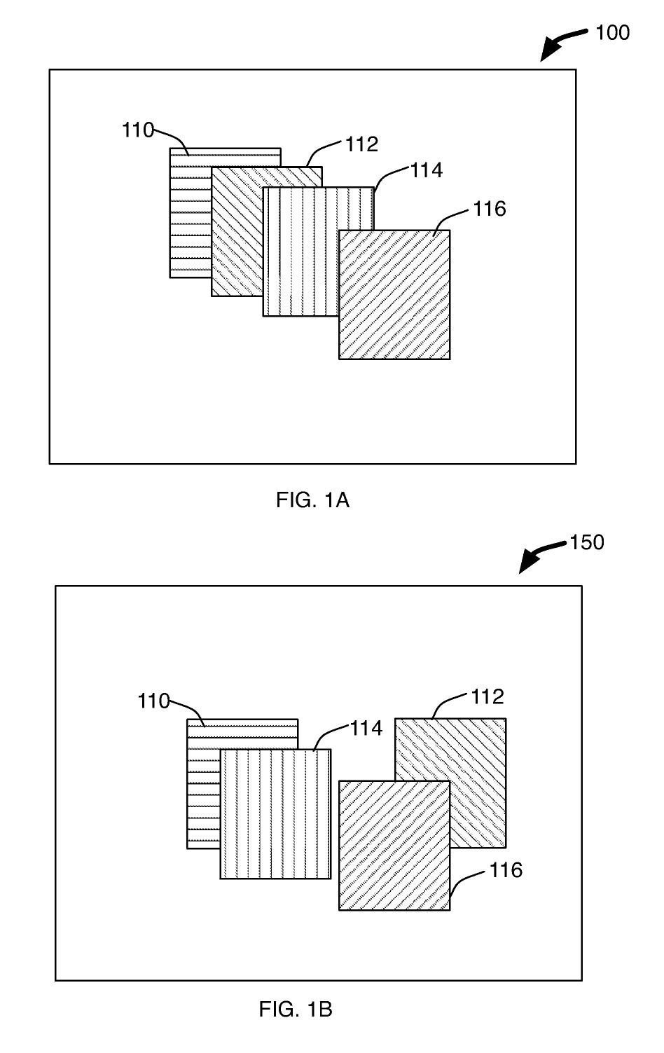

An electronic device can display several graphical elements on a display. FIGS. 1A and 1B are schematic views of illustrative displays of graphical elements in accordance with some embodiments of the invention. Display 100, shown in FIG. 1A can include graphical elements 110, 112, 114 and 116, of which at least two elements can overlap. For example, elements 110, 112 and 114 can overlap in part, while elements 110 and 112 may not overlap with element 116. Each of the graphical elements can be associated with a depth order or a depth value that indicates the manner in which the elements overlap on the display. In the example of display 100, graphical element 110 can have a depth value of 1, element 112 can have a depth value of 2, element 114 can have a depth value of 3, and element 116 can have a depth value of 4, where higher depth values correspond to elements displayed closer to the user. In one implementation, the depth values can correspond to heights along an axis extending vertically out of the display. In some embodiments, one or more graphical elements can be incorporated in one or more layers, where the layers are associated with depth values or a depth order. For clarity, however, the following discussion will describe various embodiments in the context of graphical elements.

In some embodiments, a user can move individual elements on the display without changing the depth order of the elements. For example, the user can select a particular element to drag to a different position. Display 150, shown in FIG. 1B, can include elements 110, 112, 114 and 116. The user can select one or more of the elements to move in a particular manner. For example, the user can select one or more elements to move, rotate, scale, or otherwise adjust the display of one or more selected elements while the depth order of the elements can remain the same. In the example of display 150, a user can have dragged element 112 such that it overlaps only with element 116, and no longer overlaps with elements 110 and 114, as in display 100. Despite displacing element 112, the depth value of element 112 remains at 2. In other words, the difference in depth order between overlapping elements 112 and 116 is more than one (e.g., there is at least one other element having a depth value between the overlapping elements).

The user can adjust the depth order of individual elements or layers on which elements are displayed using any suitable approach. In some embodiments, the user can provide an instruction for moving an element to the front or back of the depth order. For example, a user can select a graphic element and provide a “send to front” or “send to back” instruction. In response to receiving the instruction, the electronic device can change the depth value of the particular element to be the smallest value (e.g., a value of 1) for an instruction to send the element to the back of the depth order, or the electronic device can change the depth value of the particular element to be the largest value (e.g., a value of 4) for an instruction to send the element to the front of the depth order. In some embodiments, the electronic device can change the depth values of other, non-selected elements to accommodate for the new value of selected graphic element.

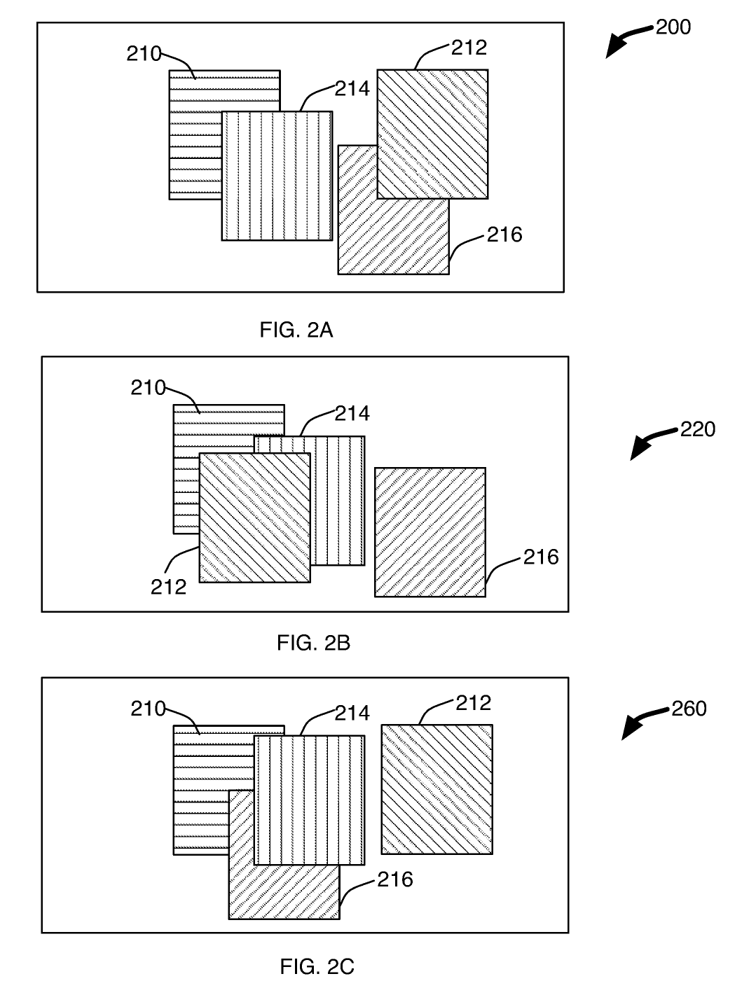

In some embodiments, a user can instead or in addition change the depth order of a particular graphical element by an amount such that a graphic element does not reach the top-most or bottom-most depth value. In particular, a user can move an element up or down along a depth axis such that the element moves above or below the nearest overlapping graphical element. FIGS. 2A-2C are schematic views of illustrative displays of several graphical elements in which the depth value of an element changes by more than one in accordance with some embodiments of the invention. Display 200, shown in FIG. 2A, can include graphical elements 210, 212, 214 and 216, which can include some or all of the features of corresponding elements 110, 112, 114 and 116 (FIGS. 1A and 1B). In contrast with display 150 (FIG. 1B), however, the relative position of elements 212 and 216 has changed in display 200. In particular, element 212 is displayed over element 216. The user can direct the device to display graphical elements 210, 212, 214 and 216 using any suitable approach including, for example, by initially starting with display 150 (FIG. 1B), in which graphical elements 112 and 116 overlap, and graphical element 114 has a depth value between those of elements 112 and 116.

Starting with display 150, the user can provide an instruction either to bring element 112 (becoming element 212) forward over element 116 (becoming element 216), or the user can instead send element 116 backward behind element 112. The electronic device can provide the appropriate instruction using any suitable approach. In some embodiments, the electronic device can provide an instruction to bring forward (or send backward) a selected graphical element. Unlike existing systems by which the electronic device simply increases (or decreases) a depth value of the selected graphical element by one (e.g., move the graphical element above the next graphical element in the depth order), the electronic device can change the depth value of the selected graphical element based on the graphical elements overlapping with the selected graphical element. Using this approach, a user can avoid providing an instruction to change the depth order a graphical element, but see no manifestation of the change in depth order due to adjacent depth values of non-overlapping graphical elements.

In the example of FIG. 2A, a user can select graphical element 212, and provide an instruction to move the graphical element forward. In response to receiving the instruction, the electronic device can identify the graphical element that overlaps with the selected element and has the closest depth value to that of the selected element (e.g., closest graphical element overlapping above the selected element). In the example of display 200, the electronic device can identify element 216, even though element 214 has a depth value that splits those of elements 212 and 216. The electronic device can then change the depth value of element 212 to be higher than that of element 216, and re-render the display showing element 212 over element 216. As shown in display 220 of FIG. 2B, when the user moves element 212, the element remains above element 216, and above other elements that are below element 216 (e.g., above elements 210 and 214).

Alternatively, in the example of FIG. 2A, a user can select element 216, and provide an instruction to move the graphical element backward. In response to receiving the instruction, the electronic device can identify the graphical element that overlaps with the selected element and has the closest depth value to that of the selected element (e.g., closest graphical element overlapping below the selected element). In the example of display 200, the electronic device can identify element 212, even though element 214 has a depth value that splits those of elements 212 and 216 (e.g., the depth values of elements 212 and 216 are not sequential). The electronic device can then change the depth value of element 216 to be lower than that of element 212, and re-render the display showing element 216 under element 212 (e.g., the depth order of element 216 changes by at least two depth orders). As shown in display 240 of FIG. 2C, when the user moves element 216, the element remains below element 212 and other elements above element 212 (e.g., element 214), but is above elements that were previously below element 212 (e.g., element 210).

The user can provide an instruction to move a particular element forward or backward using any suitable approach. In some embodiments, a portion of an input interface can be dedicated to changing the depth order of displayed elements (e.g., a dedicated button). Alternatively, the electronic device can enable a particular input of an input interface to be associated with the instructions (e.g., an input provided when particular content is displayed, or when specific features are enabled). In some embodiments, the electronic device can instead or in addition display one or more selectable options for changing the depth order of displayed elements. For example, the electronic device can display one or more menus (e.g., a pop-up menu with options for “send to back,” “send backward,” “bring forward,” and “bring to front”), display screens, buttons, selectable options, or combinations of these.

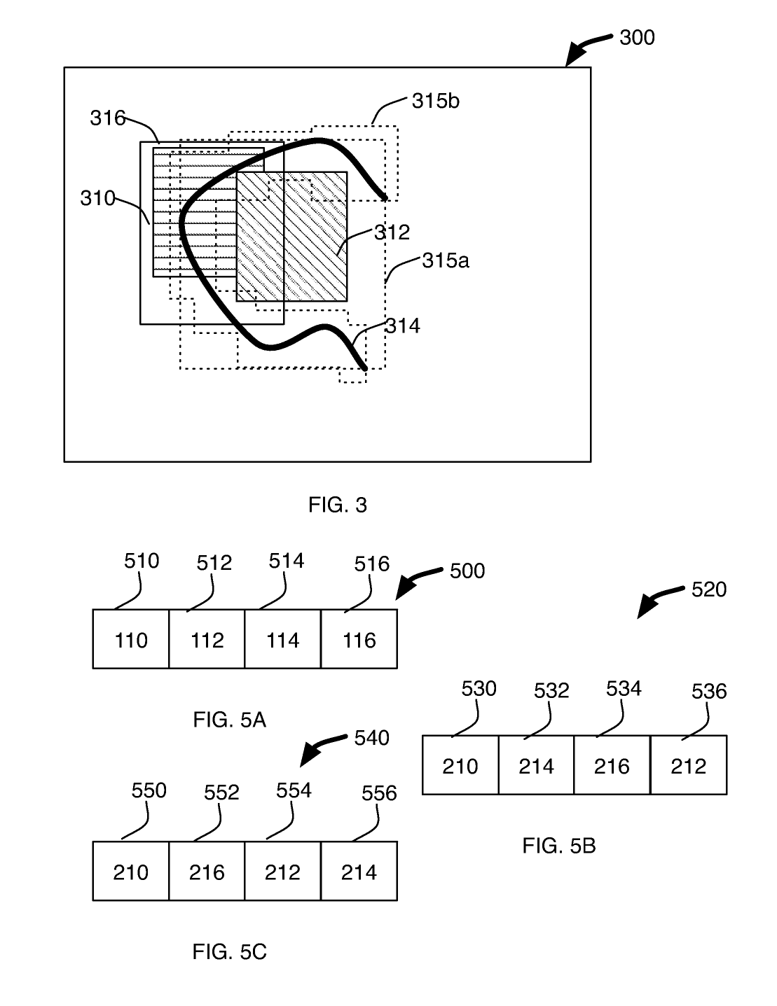

The electronic device can use any suitable approach for determining how to much to change a depth order of a graphical element in response to receiving an instruction to move the graphical element forward or backward. In some embodiments, the electronic device can first identify a selected graphical element, and then identify other displayed graphical elements that at least partially overlap with the selected graphical element. FIG. 3 is a schematic view of an illustrative display having several displayed graphical elements in accordance with one embodiment of the invention. Display 300 can include graphical element 310 having a lowest depth order, followed by graphical element 312, graphical element 314, and graphical element 316. Graphical elements 310 and 312 can include elements defining a closed surface, where the surface enclosed by a periphery is filled. Graphical element 314 can include an open line having a particular thickness, and graphical element 316 can include a closed line having a particular thickness, where element 316 encloses a surface that is not filled.

The electronic device can use any suitable approach for determining whether two displayed graphical elements intersect or overlap. In some embodiments, the electronic device can identify a drawing box associated with each of the displayed elements, and identify intersections between the drawing boxes. When the graphical element defines a filled surface, the drawing box can include the surface enclosed by a periphery of the element (e.g., the displayed region of elements 310 and 312). When the element defines an open line (e.g., element 314), the drawing box can include just the path of the line, a region that includes the lines and substantially follows the path of the line (e.g., boundary box following the line 315a), a region in which the line is constrained (e.g., rectangular box that includes all of the line, as if the line where closed 315b), or combinations of these. When the element defines a closed line or a periphery for an empty region, the drawing box can include the line forming the periphery, or a region that includes the line and at least part of the surface enclosed within the line.

Based on the selection of the drawing box, two elements may or may not intersect. For example, if the drawing box for element 314 is selected to be the line itself, element 314 intersects with elements 310 and 316, but not with element 312. Alternatively, if the drawing box is selected as a region that includes the element (e.g., drawing box 315a or drawing box 315b), element 314 intersects with elements 310, 312 and 316. Similarly, if the drawing box for element 316 is selected to include only the line defining the boundary, element 316 may not intersect with element 310. Alternatively, if the electronic device selects a drawing box that includes the surface constrained within the closed line, elements 316 and 310 can intersect.

Using the drawing boxes, the electronic device can identify the particular graphical elements that intersect with a selected graphical element. Upon identifying the intersecting graphical elements, the electronic device can compare the depth orders of the elements to identify the specific intersecting or overlapping graphical elements that are immediately above or below the selected graphical element in the depth order. In some embodiments, the electronic device can instead or in addition only identify the particular intersecting graphical element that is nearest to the selected graphical element in depth order in the direction of a received instruction (e.g., above to bring forward, below to send backward).

In some embodiments, the electronic device can instead or in addition first identify the graphical elements that are above or below a selected graphical element, and determine an ordering of the graphical elements based on depth order relative to the selected graphical element. The electronic device can then, in turn and in the determined ordering, determine whether drawing boxes associated with each of the identified graphical elements intersect with a drawing box associated with the selected graphical element. Using this approach, the electronic device can easily identify the nearest overlapping graphical element in depth order.

In some embodiments, the electronic device can determine that no graphical element overlaps with a selected graphical element in a particular direction (e.g., forward or backward, as determined from a received user instruction). In response to determine that no graphical element overlaps, the electronic device can ignore the received instruction, or change the depth order of the graphical element in the instructed direction by a single level (e.g., revert to a default mode by which a graphical element moves forward or backward by single depth values).

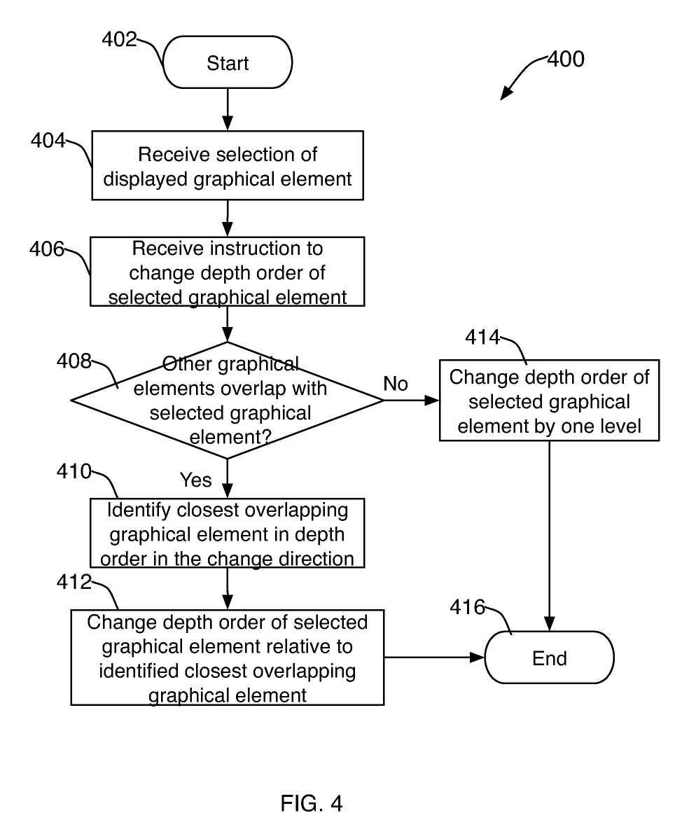

FIG. 4 is a flowchart of an illustrative process for changing a depth order of a graphical element in accordance with one embodiment of the invention. Process 400 can begin at step 402. At step 404, the electronic device can receive a selection of a displayed graphical element. For example, the electronic device can display several graphical elements, and receive a selection of one of the elements from an input interface. At step 406, the electronic device can receive an instruction to change the depth order of the selected graphical element. For example, the electronic device can receive an instruction to move the selected graphical element forward or backward relative to other graphical elements.

At step 408, the electronic device can determine whether other graphical elements overlap with the selected graphical element. For example, the electronic device can compare the position and sizes of drawing boxes of the displayed graphical elements, and determine whether one or more of the displayed graphical elements have drawing boxes that intersect with the drawing box of the selected graphical element. In some embodiments, the electronic device can determine whether other graphical elements having a particular depth order relative to the depth order of the selected graphical element overlap with the selected graphical element. For example, if the received instruction corresponds to bringing the selected graphical element forward, the electronic device can determine only whether other graphical elements positioned above or over the selected graphical element overlap with the selected graphical element. If the electronic device determines that at least one other graphical element overlaps with the selected graphical element, process 400 can move to step 410. At step 410, the electronic device can identify the closest overlapping graphical element in depth order in the direction of the change of depth order. For example, the electronic device can identify the overlapping graphical element that has the closest depth order underneath the depth order of the selected element when the received instruction corresponds to an instruction to send the selected element backward. At step 412, the electronic device can change the depth order of the selected graphical element relative to the identified closest overlapping graphical element. For example, the electronic device can change the depth order of the selected graphical element to be one higher or lower than the identified closest graphical element based on the direction in which the depth order of the selected graphical element is to change. Process 400 can then end at step 416.

If, at step 408, the electronic device instead determines that other graphical elements do not overlap with the selected graphical element, process 400 can move to step 414. At step 414, the electronic device can change the depth order of the selected graphical element by one level. For example, the electronic device can bring a selected graphical element forward or backward by one level. If the graphical element has already reached a boundary in the depth order (e.g., the selected graphical element is already at the front or at the back), the electronic device can perform no action. Process 400 can then end at step 416.

The electronic device can store the depth order of several graphical elements using any suitable data structure. FIGS. 5A-5C are schematic views of an illustrative data structure for storing depth order information in accordance with some embodiments of the invention. Data structure 500, shown in FIG. 5A, can include any suitable data structure in which data structure entries are associated with an order. For example, data structure 500 can include an array, a list, a stack, or combinations of these. Data structure 500 can have any suitable length including, for example, a length selected based on the number of graphical elements or layers of elements provided on a display. In some embodiments, the size of data structure 500 can vary dynamically, or the size can remain constant, but can include dummy or blank entries. Data structure 500 can include entries 510, 512, 514 and 516 each associated with a different depth order. For example, entry 510 can correspond to a lowest depth (e.g., element displayed the farthest away from a user), and entry 516 can correspond to a highest depth. Entries 512 and 514, between entries 510 and 514, can represent a gradient of increasing depths. Each entry can include information identifying a particular layer or element. In the example of display 500, each entry can include information identifying a graphical element provided in display 100 (FIG. 1) that is associated with the entry. In particular, element 110 is the farthest back and is therefore associated with entry 510, element 112 is the next farthest back and is associated with entry 512, element 114 is the next farthest back and associated with entry 514, and element 516 is the closest to the user and associated with entry 516.

Individual graphical elements can be associated with a particular entry in a data structure using any suitable approach. In some embodiments, each entry can include a pointer to a particular graphical element. Alternatively, each entry can store information describing the graphical element. As still another example, data structure 500 can be replicated and stored as metadata associated with each of the graphical elements.

To change the depth order in which graphical elements are displayed, the electronic device can change the order in which graphical elements are provided in data structure 500. Data structure 520, shown in FIG. 5B, can represent the graphical elements of display 220 (FIG. 2B) in which element 112 (becoming element 212) moves above or in front of element 116 (becoming element 216). Data structure 520 can include entries 530, 532, 534 and 536, which can have some or all of the features of corresponding entries 510, 512, 514 and 516, respectively. In particular, the entries of data structure 520 can be ordered such that entry 530 corresponds to a back-most element, entry 536 corresponds to a front-most element, and entries 532 and 534 correspond to intermediate elements. To reflect that element 212 has been moved ahead of element 216, data structure 520 can associate element 210 with entry 530, element 214 with entry 532, element 216 with entry 534, and element 212 with entry 536. In other words, element 212 replaces the position of element 216 in the data structure (e.g., in entry 536), and the elements between elements 212 and 216 slide down towards the empty entry 532 freed by element 212. In some implementations, data structure 520 can instead or in addition remove entry 532, and add a new entry after entry 536 to achieve the same effect without having to change the associations between several elements and entries in the data structure.

By creating a data structure having an ordered listing of elements, the electronic device can quickly and easily adjust the depth order of a particular element when it moves relative to the depth order of several graphical elements in response to a single instruction. In particular, the electronic device only needs to change the order of graphical elements in the data structure to indicate that a particular element has a new depth order that is more than one level different than a prior depth order. In contrast, in embodiments where a depth value is associated with each graphical element, the electronic device may be required to change the depth value of several graphical elements to allow a particular element to move forward or backward by more than one level.

Data structure 540, shown in FIG. 5C, can represent the graphical elements of display 240 (FIG. 2C) in which element 116 (becoming element 216) moves below or behind element 112 (becoming element 212). Data structure 540 can include entries 550, 552, 554 and 556, which can have some or all of the features of corresponding entries 510, 512, 514 and 516, respectively. In particular, the entries of data structure 540 can be ordered such that entry 550 corresponds to a back-most element, entry 556 corresponds to a front-most element, and entries 552 and 554 correspond to intermediate entries. To reflect that element 216 has been moved behind element 212, data structure 520 can associate element 210 with entry 550, element 216 with entry 552, element 212 with entry 554, and element 214 with entry 556. In other words, element 216 replaces the position of element 212 in the data structure (e.g., in entry 552), and the elements between elements 212 and 216 slide down towards the empty entry 556 freed by element 216. In some implementations, data structure 520 can instead or in addition remove entry 556, and insert a new entry between entries 550 and 552 to achieve the same effect without having to change the associations between several elements and entries in the data structure.

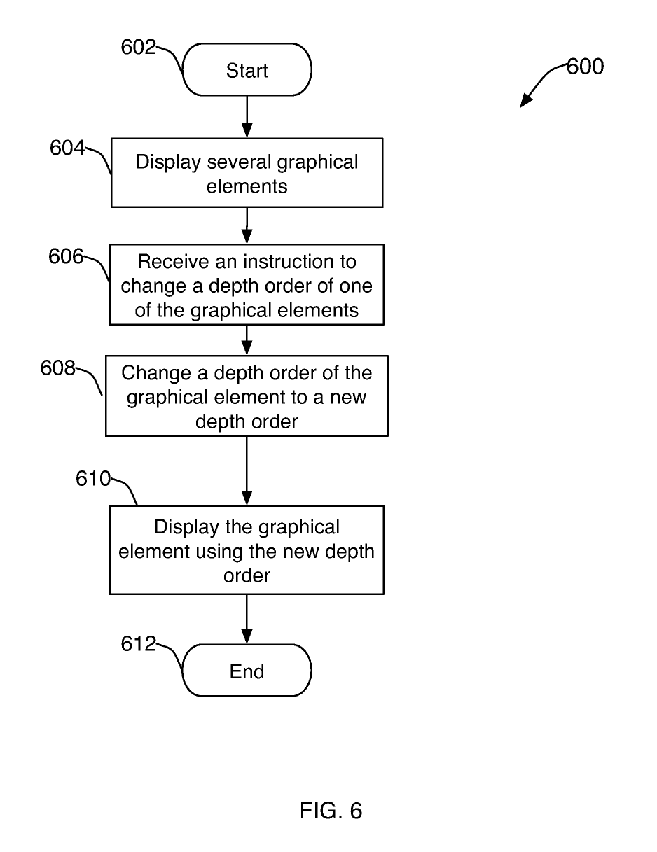

FIG. 6 is a flowchart of an illustrative process for changing the depth order of displayed graphical elements in accordance with one embodiment of the invention. Process 600 can begin at step 602. At step 604, an electronic device can display several graphical elements. For example, the electronic device can display several elements defined by a user using an application for creating content. At step 606, the electronic device can receive an instruction to change a depth order of one of the graphical elements. For example, the electronic device can receive an instruction to move a displayed graphical element forward or backward. At step 608, the electronic device can change a depth order of the graphical element from an initial depth order to a new depth order other than a front or back depth, where at least one other graphical element has a depth order between the initial depth order and the new depth order. For example, the electronic device can change the depth order of the graphical element relative to a nearest overlapping graphical element. At step 610, the electronic device can display the graphical element using the new depth order For example, the electronic device can display the graphical element at a new depth order relative to other graphical elements. Process 600 can then end at step 612.

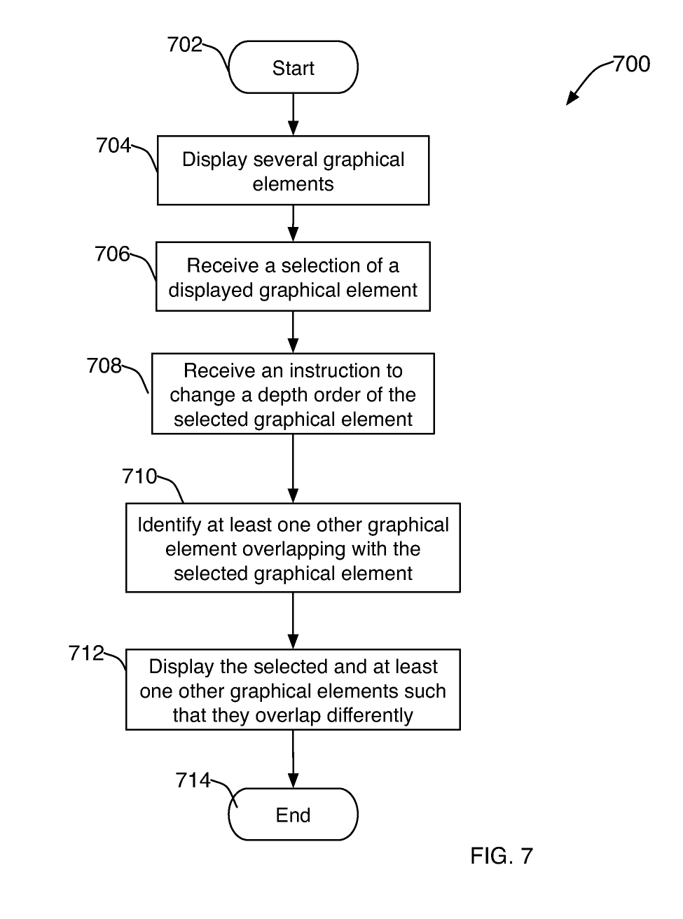

FIG. 7 is a flowchart of an illustrative process for changing the manner in which graphical elements overlap on a display in accordance with one embodiment of the invention. Process 700 can begin at step 702. At step 704, an electronic device can direct a display to display several graphical elements. For example, the electronic device can retrieve several graphical elements defined using a drawing application, and direct the device display to display the retrieved elements. At step 706, the electronic device can receive a selection of one of the graphical elements. For example, the electronic device can detect a user input corresponding to a selection of a particular graphical element. At step 708, the electronic device can receive an instruction to change a depth order of the selected graphical element. For example, the electronic device can detect an instruction to move the selected graphical element forward or backward.

At step 710, the electronic device can identify at least one other graphical element that overlaps with the selected graphical element in a particular direction (e.g., above or below the selected graphical element, or in a first order). For example, the electronic device can compare drawing boxes used for graphical elements at different depth orders. At step 712, the electronic device can direct the display to display the at least one other graphical element and the selected graphical element such that the at least one other graphical element overlaps with the selected graphical element differently. For example, the electronic device can display the graphical elements such that they overlap in a second order different from the first order. Process 700 can then end at step 714.

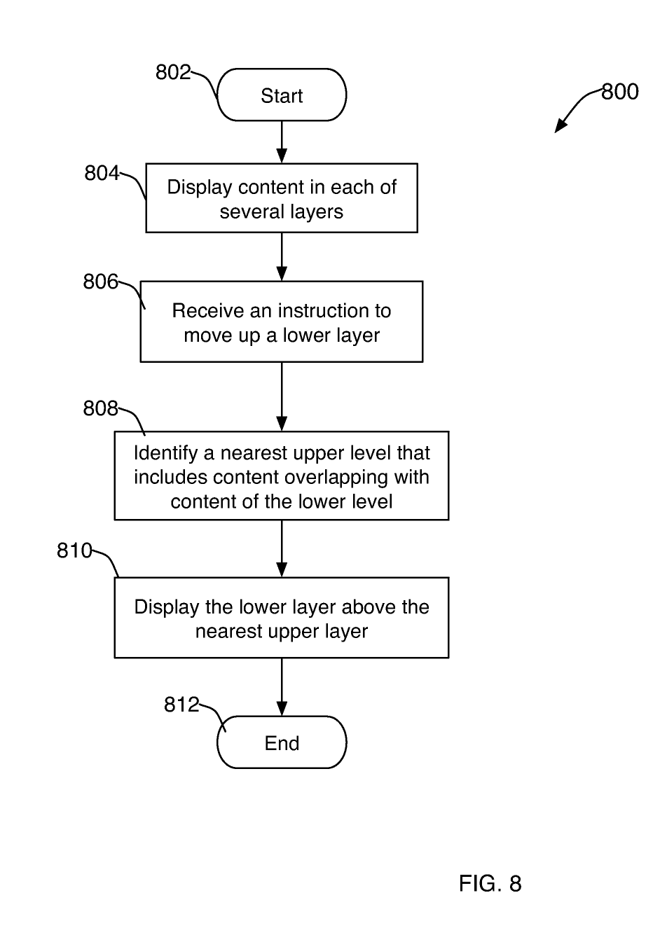

FIG. 8 is a flowchart of an illustrative process for changing a depth order associated with several displayed layers of content in accordance with one embodiment of the invention. Process 800 can begin at step 802. At step 804, the electronic device can display content in each of several layers, where content from a lower layer can be visible around content of an upper layer. For example, the electronic device can display several layers at different heights or depths within the displayed interface. At step 806, the electronic device can receive an instruction to move up a lower layer. For example, the electronic device can receive an instruction to move a particular, selected layer forward. At step 808, the electronic device can identify a nearest upper layer that includes content that overlaps with content of the lower layer. For example, the electronic device can identify drawing boxes for content of the upper and lower layers, and determine whether the drawing boxes intersect. At step 810, the electronic device can display the lower layer above the nearest upper layer such that content of the lower layer is displayed over content of the nearest upper layer. For example, the electronic device can display content of the lower layer overlaid on top of content of the nearest upper layer. In some embodiments, a top layer can be displayed above the lower layer (e.g., the lower layer is not the top or front-most layer). Process 800 can then end at step 812.

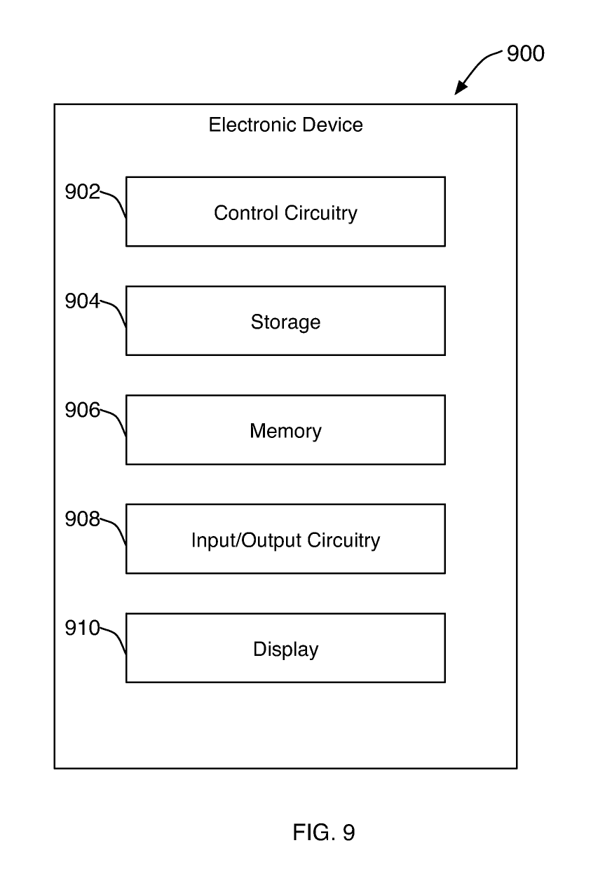

Any suitable electronic device can be used to change the depth order of displayed graphical elements. FIG. 9 is a schematic view of an illustrative electronic device in accordance with one embodiment of the invention. Electronic device 900 can include any suitable type of electronic device operative to display information to a user. For example, electronic device 900 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a music recorder, a video recorder, a gaming device, a camera, radios, medical equipment, and any other portable electronic device having a display from which a user can select a portion of displayed objects.

Electronic device 900 can include a processor or control circuitry 902, storage 904, memory 906, input/output circuitry 908, and display 910 as typically found in an electronic device of the type of electronic device 900, and operative to enable any of the uses expected from an electronic device of the type of electronic device 900 (e.g., connect to a host device for power or data transfers). In some embodiments, one or more of electronic device components 900 can be combined or omitted (e.g., combine storage 904 and memory 906), electronic device 900 can include other components not combined or included in those shown in FIG. 9 (e.g., communications circuitry or positioning circuitry), or electronic device 900 can include several instances of the components shown in FIG. 9. For the sake of simplicity, only one of each of the components is shown in FIG. 9.

Control circuitry 902 can include any processing circuitry or processor operative to control the operations and performance of electronic device 900. Storage 904 can include, for example, one or more storage mediums including a hard-drive, solid state drive, flash memory, permanent memory such as ROM, any other suitable type of storage component, or any combination thereof. Memory 906 can include cache memory, semi-permanent memory such as RAM, and/or one or more different types of memory used for temporarily storing data. In some embodiments, memory 906 and storage 904 can be combined as a single storage medium. Input/output circuitry 908 can be operative to convert (and encode/decode, if necessary) analog signals and other signals into digital data. Input/output circuitry 908 can be coupled to or include any suitable input interface, such as for example, a button, keypad, dial, a click wheel, or a touch screen, as well as any suitable output circuitry associated with output devices (e.g., audio outputs or display circuitry or components).

Display 910 can be operatively coupled to control circuitry 902 for providing visual outputs to a user. Display 910 can include any suitable type of display, including for example a liquid crystal display (LCD) (e.g., active matrix, passive matrix and the like), a monochrome display, color graphics adapter (CGA) display, enhanced graphics adapter (EGA) display, variable-graphics-array (VGA) display, super VGA display, cathode ray tube (CRT), a plasma display, a display implemented with electronic inks, or any other suitable display. Display 910 can be configured to display a graphical user interface that can provide an easy to use interface between a user of the computer system and the operating system or application running on the system.

In some embodiments, electronic device 900 can include a bus operative to provide a data transfer path for transferring data to, from, or between control processor 902, storage 904, memory 906, input/output circuitry 908, display 910 and any other component included in the electronic device.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above described embodiments of the invention are presented for purposes of illustration and not of limitation.

What is claimed is:

1. A method for changing the depth order of a displayed graphical element, comprising:
displaying a plurality of graphical elements on a display, wherein each of the graphical elements is associated with a depth order ranging between a front depth and a back depth;
receiving an instruction to change the depth order of one of the plurality of graphical elements;
changing the depth order of the one of the plurality of graphical elements from an initial depth order to a new depth order other than the front depth and the back depth in response to receiving the instruction, wherein the initial depth order and the new depth order differ by at least two depth orders; and
displaying the one of the plurality of graphical elements using the new depth order.

2. The method of claim 1, wherein receiving further comprises:
receiving at least one of an instruction to move the graphical element backward and an instruction to move the graphical element forward.

3. The method of claim 1, wherein:
at least one other graphical element has a depth order between the initial depth order and the new depth order; and
the display of the at least one other graphical element does not overlap with the display of the one of the plurality of graphical elements.

4. The method of claim 3, further comprising:
identifying drawing boxes for each of the at least one other graphical element and for the one of the plurality of graphical elements; and
determining that the identified drawing boxes do not intersect.

5. The method of claim 1, further comprising:
identifying an overlapping graphical element from the plurality of graphical elements, wherein one of the overlapping graphical element and the one of the plurality of graphical elements is displayed overlapping the other; and
displaying the overlapping graphical element and the one of the plurality of graphical elements such that the other of the one of the overlapping graphical element and the one of the plurality of graphical elements is displayed overlapping the other in response to changing.

6. The method of claim 5, further comprising:
changing the depth order of the one of the plurality of graphical elements relative to a depth order of the overlapping graphical element.

7. The method of claim 6, wherein:
depth order is stored in an ordered array comprising a plurality of entries each associated with one of the plurality of graphical elements; and
changing the depth order of the one of the plurality of graphical elements comprises changing the position in the ordered array of the entry associated with the one of the plurality of graphical elements to a position in the ordered array adjacent to a position of an entry associated with the overlapping graphical element.

8. The method of claim 7, wherein:
the entries associated with the one of the plurality of graphical elements and with the overlapping element are offset by at least one other entry prior to changing the depth order.

9. An electronic device for changing the manner in which graphical elements overlap on a display, comprising control circuitry and a display, the control circuitry operative to:
direct the display to display a plurality of graphical elements;
receive a selection of one of the plurality of graphical elements;
receive an instruction to change a depth order of the selected one of the plurality of graphical elements;
identify at least one other graphical element that overlaps with and at least partially obstructs from view the selected one of the plurality of graphical elements, wherein depth orders associated with each of the at least one other graphical element and the selected one of the plurality of graphical elements are not sequential; and
direct the display to change the display such that the at least one other graphical element overlaps with and does not at least partially obstruct from view the selected one of the plurality of graphical elements.

10. The electronic device of claim 9, wherein the control circuitry is further operative to:
receive an instruction to change a depth order of the selected one of the plurality of graphical elements in a particular direction; and
identify the at least one other graphical element that is a closest overlapping element with the selected one of the plurality of graphical elements in the particular direction.

11. The electronic device of claim 9, wherein the control circuitry is further operative to:
identify drawing boxes for each of the plurality of elements; and
determine which of the identified drawing boxes intersect with a drawing box of the selected one of the plurality of graphical elements.

12. The electronic device of claim 9, wherein the control circuitry is further operative to:
define an ordered data structure comprising a plurality of entries, wherein each of the entries is associated with a different graphical element, and wherein the position of each of the entries within the ordered data structure defines the depth order of the associated graphical elements.

13. The electronic device of claim 12, wherein the control circuitry is further operative to:
change the position of an entry associated with the selected one of the plurality of graphical elements in response to receiving an instruction to change the depth order.

14. The electronic device of claim 13, wherein:
an entry associated with the at least one other graphical element is offset from the entry associated with the selected one of the plurality of graphical elements by at least one intermediate entry before receiving the instruction to change the depth order.

15. The electronic device of claim 12, wherein:
the ordered data structure comprises at least one of:
an array;
a stack; and
a list.

16. The electronic device of claim 9, wherein the control circuitry is further operative to:
direct the display to display at least a third graphical element, wherein the third graphical element overlaps with and at least partially obstructs the at least one other graphical element and the selected one of the plurality of graphical elements.

17. A method for changing depth orders associated with a plurality of displayed layers of content, comprising:
displaying content in each of a plurality of layers, wherein content from a lower layer can be visible around content of an upper layer;
receiving an instruction to move up the lower layer;
identifying a nearest upper layer comprising content that overlaps with content of the lower layer; and
displaying the lower layer above the nearest upper layer such that content of the lower layer is displayed over content of the nearest upper layer, wherein at least a top layer is displayed above the lower layer and the nearest upper layer.

18. The method of claim 17, further comprising:
detecting an intermediate layer between the lower layer and the nearest upper layer, wherein content of the intermediate layer does not overlap with content of the lower layer.

19. The method of claim 17, further comprising:
retrieving drawing boxes associated with content of each of the layers; and
determining whether retrieved drawing boxes of different layers intersect to determine whether content from different layers overlaps.

20. Computer readable media for changing the depth order of a displayed graphical element, comprising computer readable code recorded thereon for:
displaying a plurality of graphical elements on a display, wherein each of the graphical elements is associated with a depth order ranging between a front depth and a back depth;
receiving an instruction to change the depth order of one of the plurality of graphical elements;
changing the depth order of the one of the plurality of graphical elements from an initial depth order to a new depth order other than the front depth and the back depth, wherein at least one other graphical element has a depth order between the initial depth order and the new depth order in response to receiving the instruction; and
displaying the one of the plurality of graphical elements using the new depth order.
